(19) United States
(12) Patent Application Publication
(10) Pub. No.: US 2025/0300735 A1
(43) Pub. Date: Sep. 25, 2025

(54) OPTICAL TRANSMITTER-RECEIVER MODULE AND INSPECTION SYSTEM

(71) Applicant: Nippon Telegraph and Telephone Corporation, Tokyo (JP)

(72) Inventors: Kentaro Honda, Tokyo (JP); Yusuke Nasu, Tokyo (JP); Masayuki Takahashi, Tokyo (JP)

(21) Appl. No.: 18/863,257

(22) PCT Filed: Jun. 20, 2022
(86) PCT No.: PCT/JP2022/024485

§ 371 Date: Nov. 5, 2024

(51) Int. Cl. H04B 10/40; H04B 10/079

(52) U.S. Cl. CPC H04B 10/40; H04B 10/0795

(57) ABSTRACT

An optical transmission/reception module includes an optical chip including a light transmission device and a light receiving device, a transmission analog IC, a reception analog IC, a signal processing LSI, a level conversion circuit that converts an intensity monitor signal output from a driver circuit into a level compatible with a gain control signal of a transimpedance amplifier, a switch provided between an intensity monitor terminal of the driver circuit and an input terminal of the level conversion circuit, and a switch provided between an output terminal of the level conversion circuit and a gain control terminal of the transimpedance amplifier.

### CROSS-REFERENCE TO RELATED APPLICATIONS

This application is a national phase entry of PCT Application No. PCT/JP2022/024485, filed on Jun. 20, 2022, which application is hereby incorporated herein by reference.

### TECHNICAL FIELD

The present invention relates to an optical transmission/reception module in which a plurality of devices such as an optical chip, an analog IC, and a signal processing LSI are integrated into one package and to an inspection system for the optical transmission/reception module.

### BACKGROUND

In the optical communication field, integration of a plurality of devices such as an optical chip, an analog integrated circuit (IC), and a signal processing large scale integration (LSI) into one package has advanced in order to increase a communication capacity and reduce power consumption. A system becomes complicated as more devices are integrated into one package, and thus the number of inspection items required for shipping inspection or the like increases, and a required inspection time also tends to increase. The increase in inspection time leads to an increase in product cost, and thus the inspection time needs to be reduced.

As disclosed in Patent Literature 1, it has been conventionally possible to come into direct contact with a terminal of an optical module via a spring connector or the like to confirm whether or not wiring is correctly connected to a device in the optical module.

FIG. 14 is a flowchart showing an inspection process of a conventional optical module. In inspection of an optical module after a package is assembled, as disclosed in Patent Literature 1, conduction inspection of each terminal of the optical module is performed by connecting the terminal of the optical module and an inspection device via a spring connector or the like (step S100 in FIG. 14).

When the conduction inspection is normal (YES in step S101 in FIG. 14), system inspection is performed to check whether or not there is an abnormality in operation of the optical module (step S102 in FIG. 14). Meanwhile, the system inspection is not performed on the optical module having a conduction failure in order to reduce the inspection time.

In an optical module in which a plurality of devices such as an optical chip, an analog IC, and a signal processing LSI are integrated into one package, for example, as shown in FIG. 15, some of terminals 102 of a signal processing LSI 101 and some of terminals 104 of an analog IC 103, which are mounted on a printed circuit board (PCB) 100, are connected to terminals 105 for connection to the outside of the package. Therefore, the conduction inspection of the terminals 102 and 104 connected to the terminals 105 can be performed.

Meanwhile, signal wiring 106 between the signal processing LSI 101 and the analog IC 103 is not connected to the terminal 105, and thus it is difficult to find a failure in the conduction inspection. Therefore, even if there is an abnormality in connection of the signal wiring 106, the abnormality cannot be found until the end of the inspection process, which may lead to a waste of time.

### CITATION LIST

### Patent Literature

Patent Literature 1: JP 2020-194041 A

### SUMMARY

### Technical Problem

Embodiments of the present invention have been made to solve the above problems, and an object thereof is to provide an optical transmission/reception module and an inspection system capable of improving inspection efficiency.

### Solution to Problem

An optical transmission/reception module of embodiments of the present invention includes: an optical chip including a light transmission device and a light receiving device; a transmission analog IC that drives the light transmission device by using a driver circuit in response to a transmission signal; a reception analog IC that amplifies a signal output from the light receiving device by using a transimpedance amplifier; a signal processing LSI that outputs the transmission signal to the transmission analog IC and processes the signal amplified by the reception analog IC to obtain a reception signal; a level conversion circuit that converts an intensity monitor signal output from the driver circuit into a level compatible with a gain control signal of the transimpedance amplifier; a first switch provided between an intensity monitor terminal of the driver circuit and an input terminal of the level conversion circuit; and a second switch provided between an output terminal of the level conversion circuit and a gain control terminal of the transimpedance amplifier.

### Advantageous Effects of Embodiments of the Invention

According to embodiments of the present invention, an optical

transmission/reception module is provided with a level conversion circuit that converts an intensity monitor signal output from a driver circuit into a level compatible with a gain control signal of a transimpedance amplifier, a first switch that connects an intensity monitor terminal of the driver circuit and an input terminal of the level conversion circuit, and a second switch that connects an output terminal of the level conversion circuit and a gain control terminal of the transimpedance amplifier, which makes it possible to simply confirm normality of connection between a signal processing LSI and a transmission analog IC and normality of connection between a reception analog IC and the signal processing LSI without performing system inspection. Therefore, it is possible to improve efficiency of inspection of the optical transmission/reception module. Further, as a result, a product cost can be suppressed.

### BRIEF DESCRIPTION OF THE DRAWINGS

FIG. 1 is a block diagram showing a configuration of an optical transmission/reception module according to a first embodiment of the present invention.

FIG. 2 is a block diagram showing a configuration of an inspection system according to the first embodiment of the present invention.

FIG. 3 is a flowchart showing an operation of an inspection device according to the first embodiment of the present invention.

FIG. 4 shows an inspection signal output from a signal processing LSI in the first embodiment of the present invention.

FIG. 5 shows an intensity monitor signal output from a driver circuit of a transmission analog IC in the first embodiment of the present invention.

FIG. 6 shows an analog signal output from a transimpedance amplifier of a reception analog IC in the first embodiment of the present invention.

FIG. 7 is a block diagram showing a configuration of an inspection system according to a second embodiment of the present invention.

FIG. 8 is a flowchart showing an operation of an inspection device according to the second embodiment of the present invention.

FIG. 9 is a block diagram showing a configuration of an inspection system according to a third embodiment of the present invention.

FIG. 10 is a block diagram showing a configuration of an inspection system according to a fourth embodiment of the present invention.

FIG. 11 is a block diagram showing a configuration of an inspection system according to a fifth embodiment of the present invention.

FIG. 12 is a block diagram showing a configuration of an inspection system according to a sixth embodiment of the present invention.

FIG. 13 is a block diagram showing a configuration example of a computer that implements the inspection device according to the first to sixth embodiments of the present invention.

FIG. 14 is a flowchart showing an inspection process of a conventional optical module.

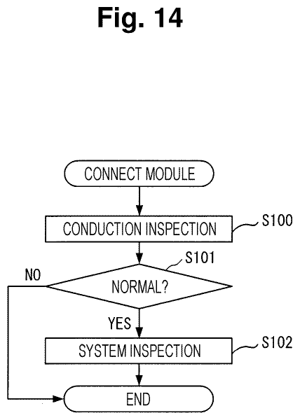

FIG. 15 is a cross-sectional view of a conventional optical module.

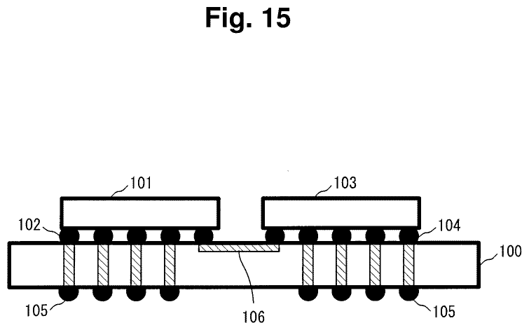

### DETAILED DESCRIPTION OF ILLUSTRATIVE EMBODIMENTS

### First Embodiment

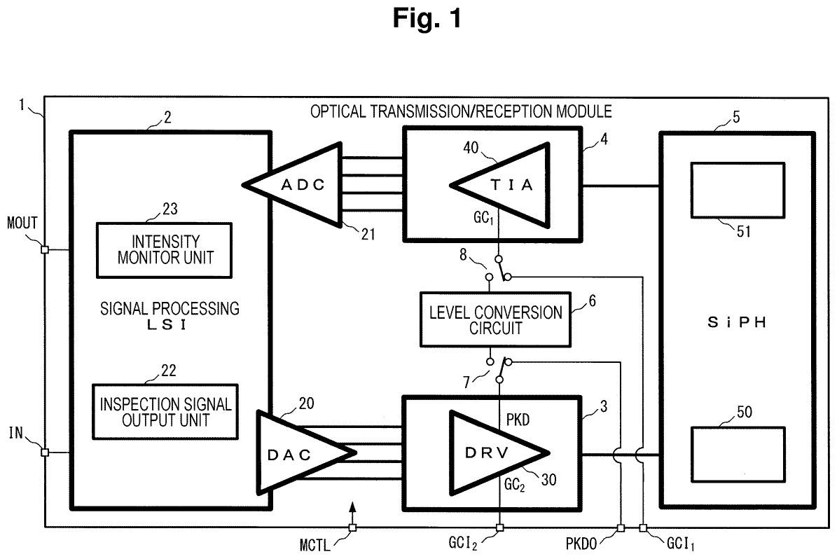

Hereinafter, embodiments of the present invention will be described with reference to the drawings. FIG. 1 is a block diagram showing a configuration of an optical transmission/reception module according to a first embodiment of the present invention. In an optical transmission/reception module 1, a signal processing LSI 2, a transmission analog IC 3, a reception analog IC 4, an optical chip 5, a level conversion circuit 6, and switches 7 and 8 are integrated.

The signal processing LSI 2 performs digital signal processing such as error correction coding, waveform shaping, and pre-equalization on a transmission signal and converts the processed digital signal into an analog signal by using a digital-to-analog converter (DAC) 20. The signal processing LSI 2 also converts an analog signal output from the reception analog IC 4 into a digital signal by using an analog-to-digital converter (ADC) 21 and performs digital signal processing such as waveform distortion compensation and error correction decoding on the digital signal, thereby obtaining a reception signal.

The transmission analog IC 3 includes a driver circuit (DRV) 30. The DRV 30 drives a light transmission device 50 such as a laser diode (LD) or an optical modulator in the optical chip 5 in response to the analog signal output from the DAC 20. The DRV 30 serves to amplify an intensity of the analog signal to a level at which the light transmission device 50 can be driven. Further, the DRV 30 has an intensity detection function that detects the intensity of the analog output signal of the DRV 30 and outputs an intensity monitor signal indicating a detection result to an intensity monitor terminal PKD.

The reception analog IC 4 includes a transimpedance amplifier (TIA) 40. The TIA 40 converts a current signal obtained by a light receiving device 51 such as a photodiode (PD) in the optical chip 5 into a voltage signal and amplifies the voltage signal. The TIA 40 is a variable gain amplifier and can adjust a gain according to a gain control signal input to a gain control terminal GC₁.

The switch 7 selectively connects the intensity monitor terminal PKD of the DRV 30 to either the input terminal of the level conversion circuit 6 or an intensity monitor terminal PKDO of the optical transmission/reception module 1. The switch 8 selectively connects the gain control terminal GC₁ of the TIA 40 to either the output terminal of the level conversion circuit 6 or a gain control terminal GCI₁ of the optical transmission/reception module 1. The switches 7 and 8 can be controlled by a mode control signal input to a mode control terminal MCTL of the optical transmission/reception module 1.

The level conversion circuit 6 converts the intensity monitor signal output from the DRV 30 and input via the switch 7 into a level compatible with the gain control signal of the TIA 40.

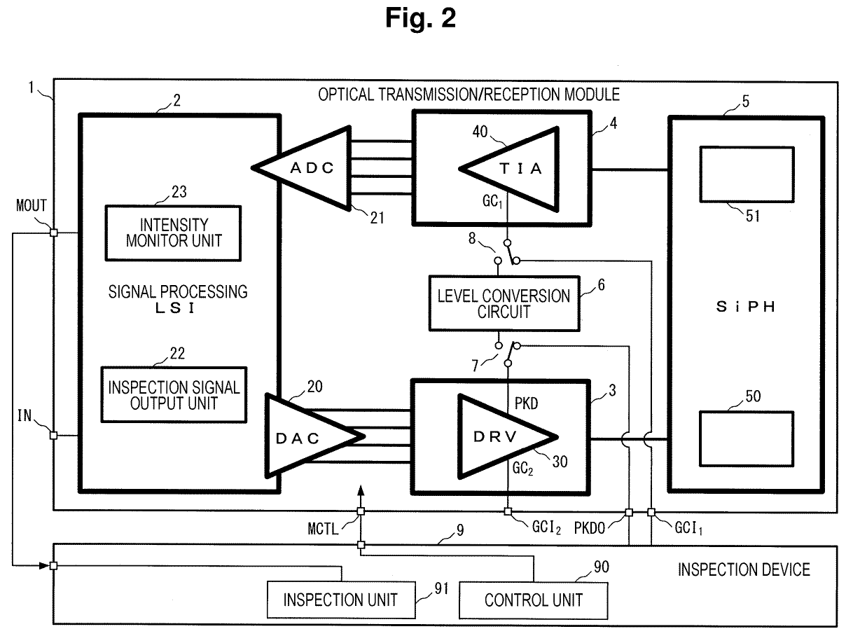

FIG. 2 is a block diagram showing a configuration of an inspection system including the optical transmission/reception module 1 and an inspection device 9. The inspection device 9 includes a control unit 90 and an inspection unit 91.

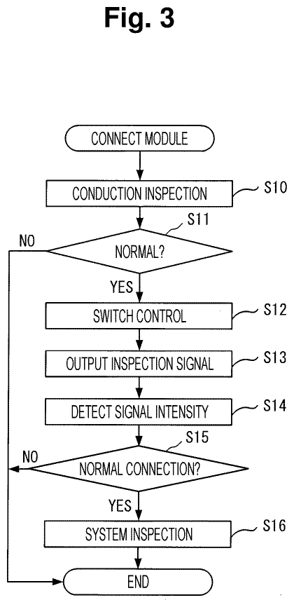

FIG. 3 is a flowchart showing an operation of the inspection device 9. After the optical transmission/reception module 1 and the inspection device 9 are connected, the inspection unit 91 of the inspection device 9 performs conduction inspection of each terminal of the optical transmission/reception module 1 as in conventional cases (step S10 in FIG. 3).

When the conduction inspection is normal (YES in step S11 in FIG. 3), simple inspection for checking normality of connection between the signal processing LSI 2 and the transmission analog IC 3 and normality of connection between the reception analog IC 4 and the signal processing LSI 2 is performed. In the simple inspection, an inspection environment is set such that light having a certain intensity is incident on the light receiving device 51 in the optical chip 5.

The control unit 90 of the inspection device 9 outputs a mode control signal. In response to the mode control signal input via the mode control terminal MCTL, the switch 7 selects the input terminal of the level conversion circuit 6, and the switch 8 selects the output terminal of the level conversion circuit 6. In this way, the intensity monitor terminal PKD of the DRV 30 and the input terminal of the level conversion circuit 6 are connected via the switch 7, and the output terminal of the level conversion circuit 6 and the gain control terminal GC₁ of the TIA 40 are connected via the switch 8 (step S12 in FIG. 3).

Note that, in a state in which there is no input of the mode control signal from the mode control terminal MCTL, the switch 7 connects the intensity monitor terminal PKD of the DRV 30 to the intensity monitor terminal PKDO of the optical transmission/reception module 1. The switch 8 connects the gain control terminal GC₁ of the TIA 40 to the gain control terminal GCI₁ of the optical transmission/reception module 1.

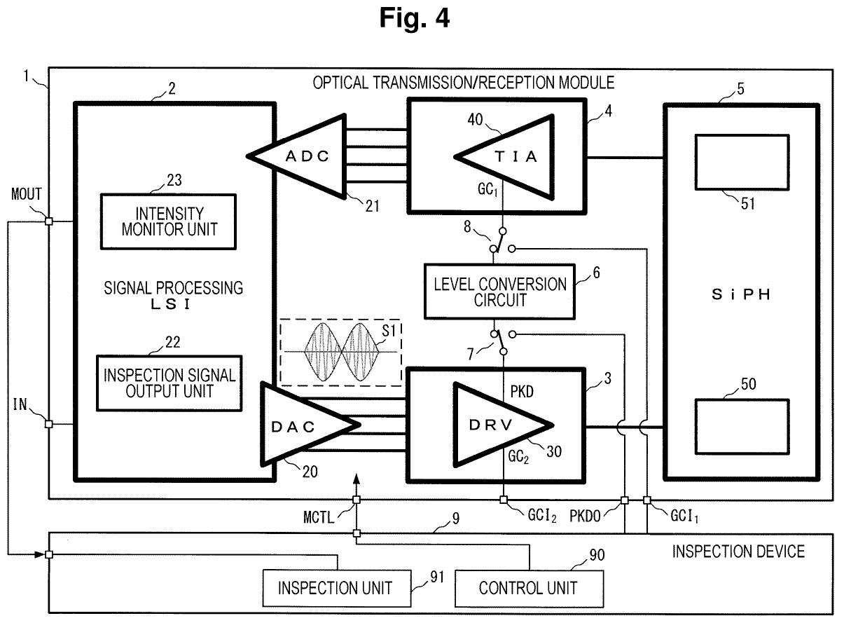

Next, an inspection signal output unit 22 of the signal processing LSI 2 outputs an inspection signal in response to, for example, an instruction from the control unit 90 of the inspection device 9 (step S13 in FIG. 3). The inspection signal is a signal whose signal intensity is periodically changed by performing intensity modulation (AM modulation) on a main signal having a frequency equivalent to that of a transmission signal for optical communication at a frequency lower than that of the main signal. The inspection signal is subjected to the digital signal processing by the signal processing LSI 2 in a similar manner to the transmission signal for optical communication, and the processed digital signal is converted into an analog signal by the DAC 20. Thus, for example, an inspection signal S1 having a waveform shown in FIG. 4 is output from the DAC 20 to the transmission analog IC 3.

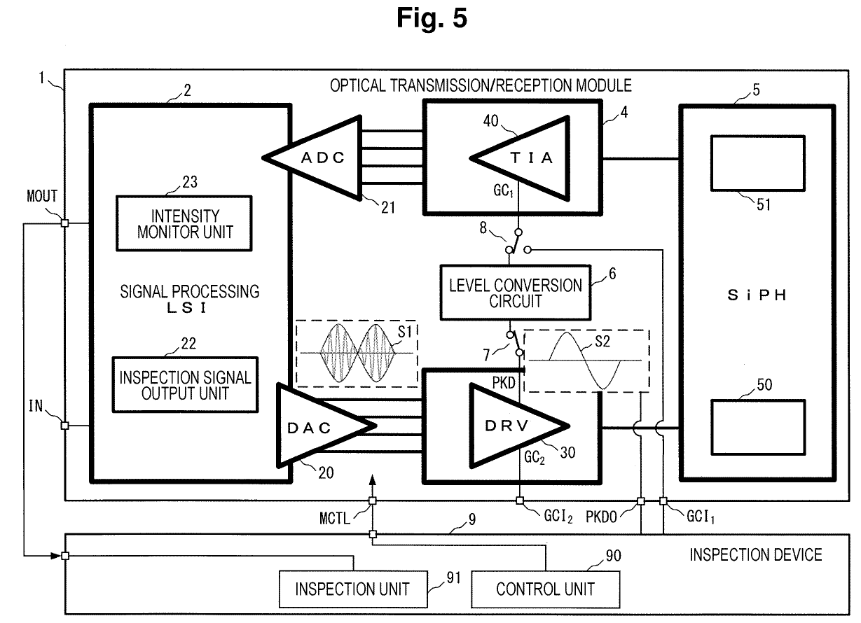

The DRV 30 of the transmission analog IC 3 amplifies the inspection signal S1 output from the DAC 20 and outputs the amplified inspection signal to the optical chip 5. At this time, the DRV 30 outputs, to the intensity monitor terminal PKD, an intensity monitor signal S2 indicating an intensity of the analog output signal to be output to the optical chip 5. Thus, for example, the intensity monitor signal S2 having a waveform shown in FIG. 5 is output from the DRV 30.

The level conversion circuit 6 converts the intensity monitor signal S2 output from the DRV 30 and input via the switch 7 into a level compatible with a gain control signal of the TIA 40 and outputs the converted intensity monitor signal to the switch 8.

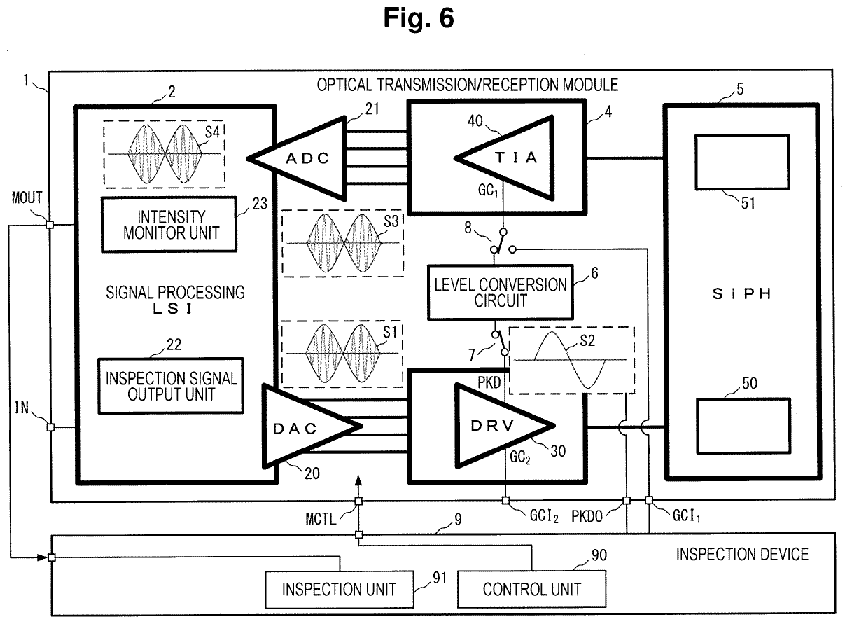

The TIA 40 of the reception analog IC 4 receives the signal input to the gain control terminal GC₁ via the switch 8 as the gain control signal and amplifies a signal output from the light receiving device 51 in the optical chip 5 with a gain corresponding to the gain control signal. When the inspection environment is set such that light having a constant intensity is incident on the light receiving device 51, an intensity of the signal output from the light receiving device 51 is constant. Meanwhile, the gain control signal is obtained by converting the level of the intensity monitor signal S2, and thus a signal intensity thereof periodically changes. Therefore, the gain of the TIA 40 periodically changes, and thus an analog signal S3 output from the TIA 40 is a signal whose intensity periodically changes as shown in FIG. 6, for example.

The ADC 21 of the signal processing LSI 2 converts the analog signal S3 output from the TIA 40 into a digital signal.

An intensity monitor unit 23 of the signal processing LSI 2 detects the intensity of the signal received from the TIA 40 via the ADC 21 (step S14 in FIG. 3). S4 in FIG. 6 shows an example of the signal intensity detected by the intensity monitor unit 23.

When both the connection between the signal processing LSI 2 and the transmission analog IC 3 and the connection between the reception analog IC 4 and the signal processing LSI 2 are normal, the signal intensity detected by the intensity monitor unit 23 periodically changes.

When the detected signal intensity has the same frequency component as an intensity change of the inspection signal, the intensity monitor unit 23 determines that the connection between the signal processing LSI 2 and the transmission analog IC 3 and the connection between the reception analog IC 4 and the signal processing LSI 2 are normal (YES in step S15 in FIG. 3).

Meanwhile, for example, when the signal from the TIA 40 cannot be detected, when the detected signal intensity is weak and is equal to or less than a threshold, or when the detected signal intensity does not have the same frequency component as the intensity change of the inspection signal, the intensity monitor unit 23 determines that at least one of the connection between the signal processing LSI 2 and the transmission analog IC 3 and the connection between the reception analog IC 4 and the signal processing LSI 2 is defective (NO in step S15).

The inspection unit 91 of the inspection device 9 receives an inspection result by the intensity monitor unit 23 from a monitor terminal MOUT of the optical transmission/reception module 1 and, when there is no problem in connection, performs system inspection for checking whether or not there is an abnormality in operation of the optical transmission/reception module 1 as in conventional cases (step S16 in FIG. 3).

At the time of the system inspection, the control unit 90 of the inspection device 9 returns the switches 7 and 8 of the optical transmission/reception module 1 to a normal state. That is, the switch 7 connects the intensity monitor terminal PKD of the DRV 30 to the intensity monitor terminal PKDO of the optical transmission/reception module 1. The switch 8 connects the gain control terminal GC₁ of the TIA 40 to the gain control terminal GCI₁ of the optical transmission/reception module 1.

As an example of the system inspection, for example, a transmission signal for inspection is input to the signal processing LSI 2 to check optical output of the light transmission device 50 in the optical chip 5, or an optical signal is input to the light receiving device 51 in the optical chip 5 to check output of a reception signal of the signal processing LSI 2. Needless to say, system inspection items are not limited thereto, and there are various system inspection items. When a result of the system inspection is normal, the inspection of the optical transmission/reception module 1 ends.

As described above, in the present embodiment, the normality of the connection between the signal processing LSI 2 and the transmission analog IC 3 and the normality of the connection between the reception analog IC 4 and the signal processing LSI 2 can be simply confirmed without performing the system inspection. This makes it possible to improve efficiency of the inspection of the optical transmission/reception module 1.

### Second Embodiment

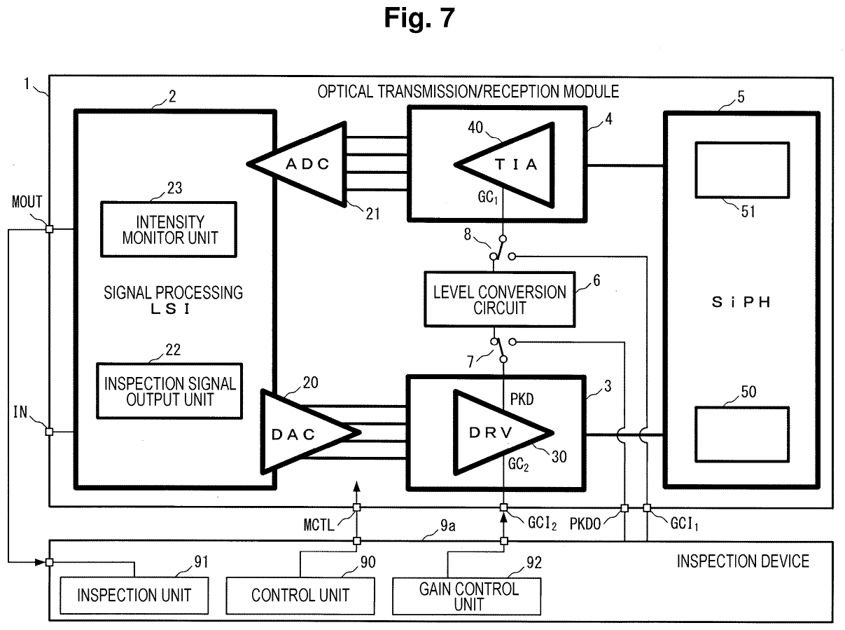

Next, a second embodiment of the present invention will be described. FIG. 7 is a block diagram showing a configuration of an inspection system including the optical transmission/reception module 1 and an inspection device 9a. The inspection device 9a includes the control unit 90, the inspection unit 91, and a gain control unit 92.

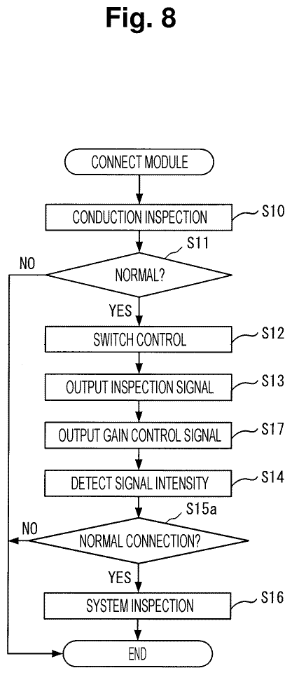

FIG. 8 is a flowchart showing an operation of the inspection device 9a. Processing in steps S10 to S13 is as described in the first embodiment.

At the time of simple inspection for checking the normality of the connection between the signal processing LSI 2 and the transmission analog IC 3 and the normality of the connection between the reception analog IC 4 and the signal processing LSI 2, the gain control unit 92 of the inspection device 9a outputs a gain control signal for controlling a gain of the DRV 30 (step S17 in FIG. 8). At this time, the gain control unit 92 outputs a gain control signal whose intensity changes at a frequency different from a frequency of an intensity change of an inspection signal output from the inspection signal output unit 22.

The gain control signal output from the gain control unit 92 is input to a gain control terminal GC₂ of the DRV 30 via a gain control terminal GCI₂ of the optical transmission/reception module 1.

The DRV 30 amplifies the inspection signal output from the DAC 20 with a gain corresponding to the gain control signal input to the gain control terminal GC₂ and outputs the amplified inspection signal to the optical chip 5.

Operations of the level conversion circuit 6, the TIA 40, and the ADC 21 are as described in the first embodiment.

As in the first embodiment, the intensity monitor unit 23 of the signal processing LSI 2 detects the intensity of the signal received from the TIA 40 via the ADC 21 (step S14 in FIG. 8).

In the present embodiment, as well as in the first embodiment, the intensity of the inspection signal is periodically changed, and, in addition, the intensity of the gain control signal input from the gain control unit 92 to the DRV 30 is changed at a frequency different from the frequency of the intensity change of the inspection signal. Therefore, when the connection between the signal processing LSI 2 and the transmission analog IC 3, the connection between the reception analog IC 4 and the signal processing LSI 2, and connection of the gain control terminal GC₂ of the DRV 30 are all normal, the signal intensity detected by the intensity monitor unit 23 has two frequency components.

When the detected signal intensity has the same frequency component as the intensity change of the inspection signal and also has the same known frequency component as the intensity change of the gain control signal input to the DRV 30, the intensity monitor unit 23 determines that the connection between the signal processing LSI 2 and the transmission analog IC 3 and the connection between the reception analog IC 4 and the signal processing LSI 2 are normal and that the connection of the gain control terminal GC₂ of the DRV 30 is also normal (YES in step S15a in FIG. 8).

Meanwhile, for example, when the signal from the TIA 40 cannot be detected, when the detected signal intensity is weak and is equal to or less than a threshold, when the detected signal intensity does not have the same frequency component as the intensity change of the inspection signal, or when the detected signal intensity does not have the same frequency component as the intensity change of the gain control signal input to the DRV 30, the intensity monitor unit 23 determines that at least one of the connection between the signal processing LSI 2 and the transmission analog IC 3, the connection between the reception analog IC 4 and the signal processing LSI 2, and the connection of the gain control terminal GC₂ of the DRV 30 is defective (NO in step S15a).

The inspection unit 91 of the inspection device 9 receives an inspection result by the intensity monitor unit 23 from the monitor terminal MOUT of the optical transmission/reception module 1 and performs system inspection when there is no problem in connection (step S16 in FIG. 8).

In the present embodiment, it is possible to confirm not only the normality of the connection between the signal processing LSI 2 and the transmission analog IC 3 and the normality of the connection between the reception analog IC 4 and the signal processing LSI 2, but also the normality of the connection of the gain control terminal GC₂ of the DRV 30.

### Third Embodiment

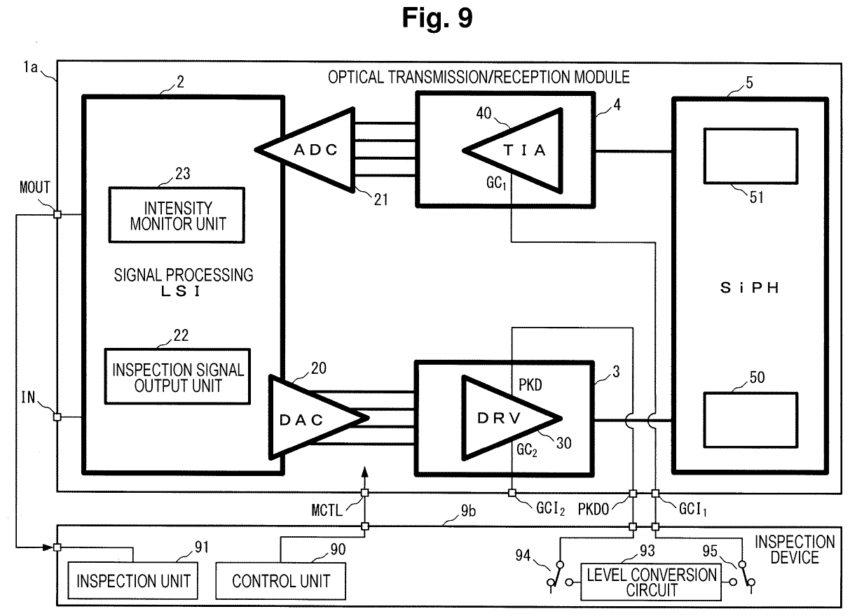

Next, a third embodiment of the present invention will be described. FIG. 9 is a block diagram showing a configuration of an inspection system including an optical transmission/reception module 1a and an inspection device 9b.

The optical transmission/reception module 1a is obtained by eliminating the level conversion circuit 6 and the switches 7 and 8 from the optical transmission/reception module 1 of the first and second embodiments, connecting the gain control terminal GC₁ of the TIA 40 to the gain control terminal GCI₁, and connecting the intensity monitor terminal PKD of the DRV 30 to the intensity monitor terminal PKDO.

The inspection device 9b includes the control unit 90, the inspection unit 91, a level conversion circuit 93, and switches 94 and 95.

The switch 94 selectively connects the intensity monitor terminal PKDO of the optical transmission/reception module 1ₐ to either an input terminal of the level conversion circuit 93 or another circuit (e.g., the inspection unit 91) in the inspection device 9b. The switch 95 selectively connects the gain control terminal GCI₁ of the optical transmission/reception module 1a to either an output terminal of the level conversion circuit 93 or another circuit (e.g. a gain control unit) in the inspection device 9b.

A flow of inspection of the optical transmission/reception module 1a is similar to that of the first embodiment, and thus an operation of the inspection device 9b will be described with reference to FIG. 3. The processing in step S10 is as described in the first embodiment.

When the conduction inspection is normal (YES in step S11 in FIG. 3), the control unit 90 of the inspection device 9b causes the switch 94 to select the input terminal of the level conversion circuit 93 and causes the switch 95 to select the output terminal of the level conversion circuit 93. In this way, the intensity monitor terminal PKD of the DRV 30 and the input terminal of the level conversion circuit 93 are connected via the switch 94, and the output terminal of the level conversion circuit 93 and the gain control terminal GC₁ of the TIA 40 are connected via the switch 95 (step S12 in FIG. 3).

As in the first embodiment, the inspection signal output unit 22 of the signal processing LSI 2 outputs an inspection signal (step S13 in FIG. 3).

The level conversion circuit 93 of the inspection device 9b converts the intensity monitor signal output from the DRV 30 and input via the intensity monitor terminal PKDO and the switch 94 into a level compatible with a gain control signal of the TIA 40 and outputs the converted intensity monitor signal to the switch 95.

The TIA 40 of the reception analog IC 4 receives the signal input to the gain control terminal GC₁ via the switch 95 and the gain control terminal GC₁ as the gain control signal and amplifies a signal output from the light receiving device 51 in the optical chip 5 with a gain corresponding to the gain control signal.

The processing in steps S14 and S15 is as described in the first embodiment.

The inspection unit 91 of the inspection device 9b receives an inspection result by the intensity monitor unit 23 from the monitor terminal MOUT of the optical transmission/reception module 1a and performs system inspection of the optical transmission/reception module 1a when there is no problem in connection (step S16 in FIG. 3).

At the time of the system inspection, the control unit 90 of the inspection device 9b causes the switch 94 to select connection to a circuit (e.g., the inspection unit 91) other than the level conversion circuit 93 and causes the switch 95 to select connection to a circuit (e.g., the gain control unit) other than the level conversion circuit 93. When a result of the system inspection is normal, the inspection of the optical transmission/reception module 1a ends.

As described above, in the present embodiment, the level conversion circuit does not need to be mounted in the optical transmission/reception module 1a. This makes it possible to reduce an area of the optical transmission/reception module 1a.

### Fourth Embodiment

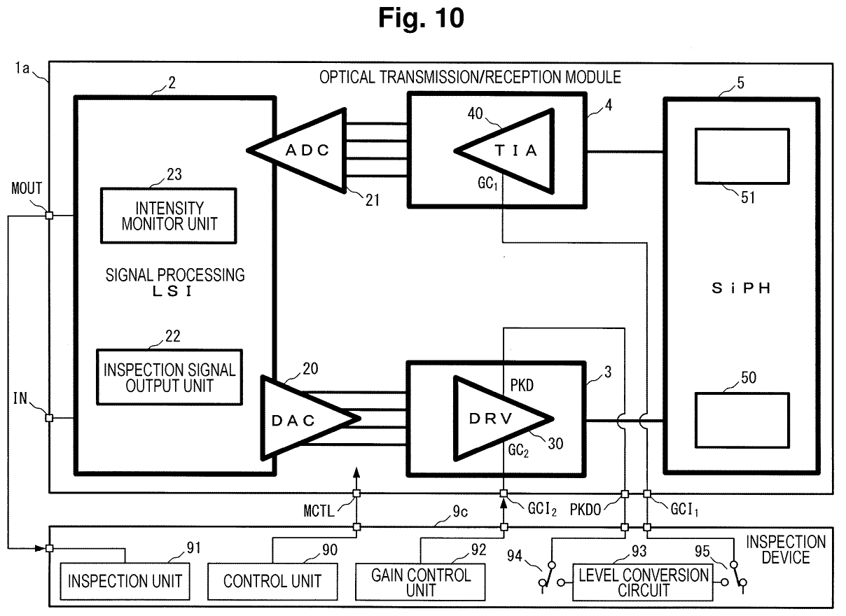

Next, a fourth embodiment of the present invention will be described. FIG. 10 is a block diagram showing a configuration of an inspection system including the optical transmission/reception module 1a and an inspection device 9c.

The inspection device 9c of the present embodiment is obtained by adding the gain control unit 92 to the inspection device 9b of the third embodiment.

The flow of the inspection of the optical transmission/reception module 1a is similar to that of the second embodiment, and thus an operation of the inspection device 9c will be described with reference to FIG. 8. The processing in step S10 is as described in the first embodiment.

As in the third embodiment, when the conduction inspection is normal (YES in step S11 in FIG. 8), the control unit 90 of the inspection device 9c causes the switch 94 to select the input terminal of the level conversion circuit 93 and causes the switch 95 to select the output terminal of the level conversion circuit 93 (step S12 in FIG. 8).

As in the first embodiment, the inspection signal output unit 22 of the signal processing LSI 2 outputs an inspection signal (step S13 in FIG. 8).

As in the second embodiment, the gain control unit 92 of the inspection device 9c outputs a gain control signal (step S17 in FIG. 8).

The DRV 30 amplifies the inspection signal output from the DAC 20 with a gain corresponding to the gain control signal input to the gain control terminal GC₂ and outputs the amplified inspection signal to the optical chip 5.

Operations of the level conversion circuit 93 and the TIA 40 are as described in the third embodiment. The processing in steps S14 and S15a is as described in the second embodiment.

The inspection unit 91 of the inspection device 9c receives an inspection result by the intensity monitor unit 23 from the monitor terminal MOUT of the optical transmission/reception module 1a and performs system inspection of the optical transmission/reception module 1a when there is no problem in connection (step S16 in FIG. 8).

In the present embodiment, as well as in the third embodiment, it is possible to reduce the area of the optical transmission/reception module 1a. Further, in the present embodiment, as well as in the second embodiment, it is possible to confirm not only the normality of the connection between the signal processing LSI 2 and the transmission analog IC 3 and the normality of the connection between the reception analog IC 4 and the signal processing LSI 2, but also the normality of the connection of the gain control terminal GC₂ of the DRV 30.

### Fifth Embodiment

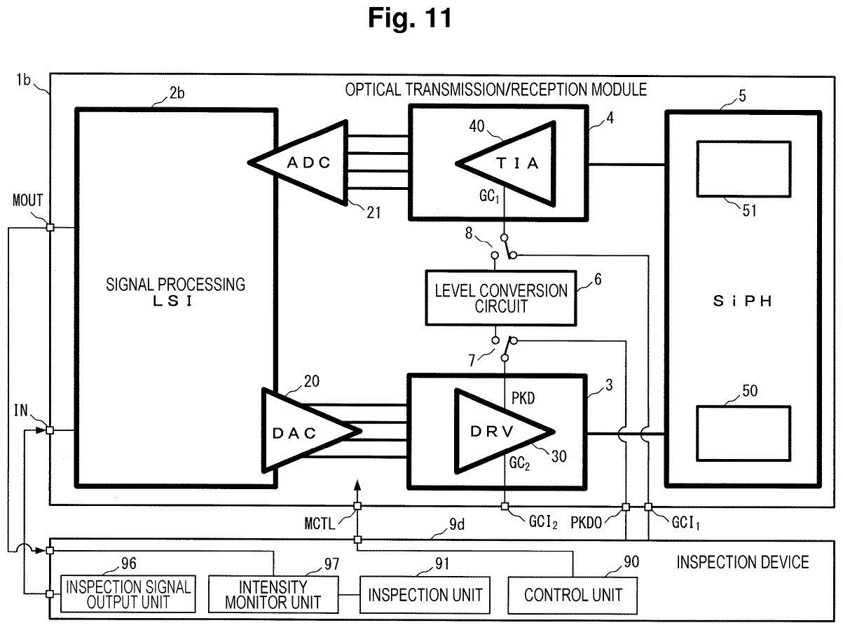

Next, a fifth embodiment of the present invention will be described. FIG. 11 is a block diagram showing a configuration of an inspection system including an optical transmission/reception module 1b and an inspection device 9d.

In an optical transmission/reception module 1b of the present embodiment, a signal processing LSI 2b, the transmission analog IC 3, the reception analog IC 4, the optical chip 5, the level conversion circuit 6, and the switches 7 and 8 are integrated.

The inspection device 9d includes the control unit 90, the inspection unit 91, an inspection signal output unit 96, and an intensity monitor unit 97.

In the first to fourth embodiments, the inspection signal output unit 22 and the intensity monitor unit 23 are provided in the signal processing LSI 2 of the optical transmission/reception module 1 or 1a. Meanwhile, in the present embodiment, the inspection signal output unit 96 and the intensity monitor unit 97 are provided in the inspection device 9d.

A flow of inspection of the optical transmission/reception module 1b is similar to that of the first embodiment, and thus an operation of the inspection device 9d will be described with reference to FIG. 3. The processing in steps S10 to S12 is as described in the first embodiment.

Next, the inspection signal output unit 96 of the inspection device 9d outputs an inspection signal in response to, for example, an instruction from the control unit 90 (step S13 in FIG. 3). The inspection signal is input from an input terminal IN of the optical transmission/reception module 1b to the signal processing LSI 2b and is subjected to the digital signal processing by the signal processing LSI 2b in a similar manner to a transmission signal for optical communication, and the processed digital signal is converted into an analog signal by the DAC 20.

Operations of the DRV 30, the level conversion circuit 6, the switches 7 and 8, the TIA 40, and the ADC 21 are as described in the first embodiment.

The intensity monitor unit 97 of the inspection device 9d receives a signal received by the signal processing LSI 2b from the TIA 40 via the ADC 21 via the monitor terminal MOUT of the optical transmission/reception module 1b and detects an intensity of the received signal (step S14 in FIG. 3).

When the detected signal intensity has the same frequency component as an intensity change of the inspection signal, the intensity monitor unit 97 determines that the connection between the signal processing LSI 2b and the transmission analog IC 3 and the connection between the reception analog IC 4 and the signal processing LSI 2b are normal (YES in step S15 in FIG. 3).

Meanwhile, for example, when the signal cannot be detected, when the detected signal intensity is weak and is equal to or less than a threshold, or when the detected signal intensity does not have the same frequency component as the intensity change of the inspection signal, the intensity monitor unit 97 determines that at least one of the connection between the signal processing LSI 2b and the transmission analog IC 3 and the connection between the reception analog IC 4 and the signal processing LSI 2b is defective (NO in step S15).

The inspection unit 91 of the inspection device 9d receives an inspection result by the intensity monitor unit 97 and performs system inspection of the optical transmission/reception module 1b when there is no problem in connection (step S16 in FIG. 3).

As described above, in the present embodiment, the inspection signal output unit and the intensity monitor unit do not need to be mounted in the signal processing LSI 2b of the optical transmission/reception module 1b. This makes it possible to reduce an area of the optical transmission/reception module 1b.

Note that only one of the inspection signal output unit 96 and the intensity monitor unit 97 may be provided in the inspection device. Further, as in the second embodiment, the gain control unit 92 may be added to the inspection device.

### Sixth Embodiment

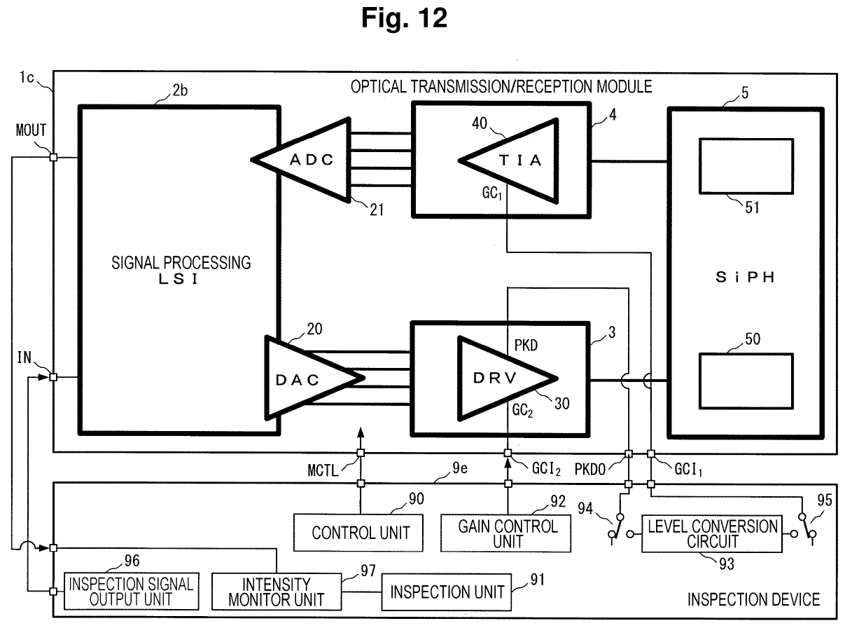

Next, a sixth embodiment of the present invention will be described. FIG. 12 is a block diagram showing a configuration of an inspection system including an optical transmission/reception module 1c and an inspection device 9e.

The optical transmission/reception module 1c is obtained by eliminating the level conversion circuit 6 and the switches 7 and 8 from the optical transmission/reception module 1b of the fifth embodiment, connecting the gain control terminal GC₁ of the TIA 40 to the gain control terminal GCI₁, and connecting the intensity monitor terminal PKD of the DRV 30 to the intensity monitor terminal PKDO.

The inspection device 9e is obtained by adding the gain control unit 92, the level conversion circuit 93, and the switches 94 and 95 to the inspection device 9d of the fifth embodiment.

An operation of the inspection device 9e is similar to that of the first to fifth embodiments, and thus detailed description thereof will be omitted.

Note that, as in the third embodiment, the inspection device may additionally include only the level conversion circuit 93 and the switches 94 and 95 and may not include the gain control unit 92.

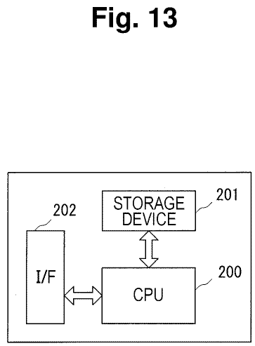

At least a part of the inspection devices 9 and 9a to 9e described in the first to sixth embodiments can be implemented by a computer including a central processing unit (CPU), a storage device, and an interface and a program that controls those hardware resources. A configuration example of the computer is shown in FIG. 13.

The computer includes a CPU 200, a storage device 201, and an interface device (I/F) 202. The I/F 202 is connected to, for example, hardware such as the switches 94 and 95, the inspection signal output unit 96, and the intensity monitor unit 97. In the computer, a program for implementing an inspection method of embodiments of the present invention is stored in the storage device 201. The CPU 200 executes the processing described in the first to sixth embodiments according to the program stored in the storage device 201.

Some or all of the above-described embodiments may be described as the following supplementary notes, but are not limited to the following.

(Supplementary note 1) An optical transmission/reception module of an embodiment of the present invention includes: an optical chip including a light transmission device and a light receiving device; a transmission analog IC that drives the light transmission device by using a driver circuit in response to a transmission signal; a reception analog IC that amplifies a signal output from the light receiving device by using a transimpedance amplifier; a signal processing LSI that outputs the transmission signal to the transmission analog IC and processes the signal amplified by the reception analog IC to obtain a reception signal; a level conversion circuit that converts an intensity monitor signal output from the driver circuit into a level compatible with a gain control signal of the transimpedance amplifier; a first switch provided between an intensity monitor terminal of the driver circuit and an input terminal of the level conversion circuit; and a second switch provided between an output terminal of the level conversion circuit and a gain control terminal of the transimpedance amplifier.

(Supplementary note 2) In the optical transmission/reception module according to Supplementary note 1, the signal processing LSI includes an inspection signal output unit that, at the time of inspection for checking normality of connection between the signal processing LSI and the transmission analog IC and normality of connection between the reception analog IC and the signal processing LSI, outputs an inspection signal whose signal intensity is periodically changed at a frequency lower than a frequency of the transmission signal to the transmission analog IC, and an intensity monitor unit that detects an intensity of the signal received from the reception analog IC at the time of the inspection.

(Supplementary note 3) An inspection system of an embodiment of the present invention includes: the optical transmission/reception module according to Supplementary note 2; and an inspection device for the optical transmission/reception module, in which: the inspection device includes a first control unit that controls the first and second switches such that, at the time of the inspection, the intensity monitor terminal of the driver circuit and the input terminal of the level conversion circuit are connected to each other, and the output terminal of the level conversion circuit and the gain control terminal of the transimpedance amplifier are connected to each other; and the intensity monitor unit determines that the connection between the signal processing LSI and the transmission analog IC and the connection between the reception analog IC and the signal processing LSI are normal in a case where the detected signal intensity has the same frequency component as an intensity change of the inspection signal.

(Supplementary note 4) In the inspection system according to Supplementary note 3, the inspection device further includes a second control unit that, at the time of the inspection, outputs, to a gain control terminal of the driver circuit, a gain control signal whose intensity changes at a frequency different from a frequency of the intensity change of the inspection signal, and the intensity monitor unit determines that the connection between the signal processing LSI and the transmission analog IC and the connection between the reception analog IC and the signal processing LSI are normal, and connection of the gain control terminal of the driver circuit is also normal in a case where the detected signal intensity has the same frequency component as the intensity change of the inspection signal and also has the same frequency component as an intensity change of the gain control signal.

(Supplementary note 5) An inspection system of an embodiment of the present invention includes: an optical transmission/reception module; and an inspection device for the optical transmission/reception module, in which: the optical transmission/reception module includes an optical chip including a light transmission device and a light receiving device, a transmission analog IC that drives the light transmission device by using a driver circuit in response to a transmission signal, a reception analog IC that amplifies a signal output from the light receiving device by using a transimpedance amplifier, a signal processing LSI that outputs the transmission signal to the transmission analog IC and processes the signal amplified by the reception analog IC to obtain a reception signal; the signal processing LSI includes an inspection signal output unit that, at the time of inspection for checking normality of connection between the signal processing LSI and the transmission analog IC and normality of connection between the reception analog IC and the signal processing LSI, outputs an inspection signal whose signal intensity is periodically changed at a frequency lower than a frequency of the transmission signal to the transmission analog IC, and an intensity monitor unit that detects an intensity of the signal received from the reception analog IC at the time of the inspection; the inspection device includes a level conversion circuit that converts an intensity monitor signal output from the driver circuit into a level compatible with a gain control signal of the transimpedance amplifier, a first switch provided between an intensity monitor terminal of the driver circuit and an input terminal of the level conversion circuit, a second switch provided between an output terminal of the level conversion circuit and a gain control terminal of the transimpedance amplifier, and a first control unit that controls the first and second switches such that, at the time of the inspection, the intensity monitor terminal of the driver circuit and the input terminal of the level conversion circuit are connected to each other, and the output terminal of the level conversion circuit and the gain control terminal of the transimpedance amplifier are connected to each other; and the intensity monitor unit determines that the connection between the signal processing LSI and the transmission analog IC and the connection between the reception analog IC and the signal processing LSI are normal in a case where the detected signal intensity has the same frequency component as an intensity change of the inspection signal.

(Supplementary note 6) An inspection system of an embodiment of the present invention includes: the optical transmission/reception module according to Supplementary note 1; and an inspection device for the optical transmission/reception module, in which: the inspection device includes an inspection signal output unit that, at the time of inspection for checking normality of connection between the signal processing LSI and the transmission analog IC and normality of connection between the reception analog IC and the signal processing LSI, outputs an inspection signal whose signal intensity is periodically changed at a frequency lower than a frequency of the transmission signal to the transmission analog IC, an intensity monitor unit that detects an intensity of the signal received from the reception analog IC at the time of the inspection, and a first control unit that controls the first and second switches such that, at the time of the inspection, the intensity monitor terminal of the driver circuit and the input terminal of the level conversion circuit are connected to each other, and the output terminal of the level conversion circuit and the gain control terminal of the transimpedance amplifier are connected to each other; and the intensity monitor unit determines that the connection between the signal processing LSI and the transmission analog IC and the connection between the reception analog IC and the signal processing LSI are normal in a case where the detected signal intensity has the same frequency component as an intensity change of the inspection signal.

(Supplementary note 7) An inspection system of an embodiment of the present invention includes: an optical transmission/reception module; and an inspection device for the optical transmission/reception module, in which: the optical transmission/reception module includes an optical chip including a light transmission device and a light receiving device, a transmission analog IC that drives the light transmission device by using a driver circuit in response to a transmission signal, a reception analog IC that amplifies a signal output from the light receiving device by using a transimpedance amplifier, and a signal processing LSI that outputs the transmission signal to the transmission analog IC and processes the signal amplified by the reception analog IC to obtain a reception signal; the inspection device includes a level conversion circuit that converts an intensity monitor signal output from the driver circuit into a level compatible with a gain control signal of the transimpedance amplifier, a first switch provided between an intensity monitor terminal of the driver circuit and an input terminal of the level conversion circuit, a second switch provided between an output terminal of the level conversion circuit and a gain control terminal of the transimpedance amplifier, an inspection signal output unit that, at the time of inspection for checking normality of connection between the signal processing LSI and the transmission analog IC and normality of connection between the reception analog IC and the signal processing LSI, outputs an inspection signal whose signal intensity is periodically changed at a frequency lower than a frequency of the transmission signal to the transmission analog IC, an intensity monitor unit that detects an intensity of the signal received from the reception analog IC at the time of the inspection, and a first control unit that controls the first and second switches such that, at the time of the inspection, the intensity monitor terminal of the driver circuit and the input terminal of the level conversion circuit are connected to each other, and the output terminal of the level conversion circuit and the gain control terminal of the transimpedance amplifier are connected to each other; and the intensity monitor unit determines that the connection between the signal processing LSI and the transmission analog IC and the connection between the reception analog IC and the signal processing LSI are normal in a case where the detected signal intensity has the same frequency component as an intensity change of the inspection signal.

(Supplementary note 8) In the inspection system according to any one of Supplementary notes 5 to 7, the inspection device further includes a second control unit that, at the time of the inspection, outputs, to a gain control terminal of the driver circuit, a gain control signal whose intensity changes at a frequency different from a frequency of the intensity change of the inspection signal, and the intensity monitor unit determines that the connection between the signal processing LSI and the transmission analog IC and the connection between the reception analog IC and the signal processing LSI are normal, and connection of the gain control terminal of the driver circuit is also normal in a case where the detected signal intensity has the same frequency component as the intensity change of the inspection signal and also has the same frequency component as the intensity change of the gain control signal.

### INDUSTRIAL APPLICABILITY

Embodiments of the present invention can be applied to a technique of inspecting an optical transmission/reception module.

### REFERENCE SIGNS LIST

1, 1a to 1c Optical transmission/reception module
2, 2b Signal processing LSI
3 Transmission analog IC
4 Reception analog IC
5 Optical chip
6, 93 Level conversion circuit
7, 8,94, 95 Switch
9, 9a to 9e Inspection device
20 DAC
21 ADC
22, 96 Inspection signal output unit
23,97 Intensity monitor unit
30 Driver circuit
40 Transimpedance amplifier
50 Light transmission device
51 Light receiving device
90 Control unit
91 Inspection unit
92 Gain control unit

1.-8. (canceled)

9. An optical transmission/reception device comprising:
an optical chip comprising a light transmission device and a light receiving device;
a transmission analog integrated circuit (IC) configured to drive the light transmission device by using a driver circuit in response to a transmission signal;
a reception analog IC configured to amplify a signal output from the light receiving device by using a transimpedance amplifier;
a signal processing large scale integration (LSI) configured to output the transmission signal to the transmission analog IC and process the signal amplified by the reception analog IC to obtain a reception signal;
a level conversion circuit configured to convert an intensity monitor signal output from the driver circuit into a level compatible with a gain control signal of the transimpedance amplifier;
a first switch disposed between an intensity monitor terminal of the driver circuit and an input terminal of the level conversion circuit; and
a second switch disposed between an output terminal of the level conversion circuit and a gain control terminal of the transimpedance amplifier.

10. The optical transmission/reception device according to claim 9, wherein the signal processing LSI comprises:
an inspection signal output circuit that, at a time of an inspection for checking normality of a connection between the signal processing LSI and the transmission analog IC and normality of a connection between the reception analog IC and the signal processing LSI, is configured to output an inspection signal whose signal intensity is periodically changed at a frequency lower than a frequency of the transmission signal to the transmission analog IC; and
an intensity monitor circuit configured to detect an intensity of the signal received from the reception analog IC at the time of the inspection.

11. An inspection system comprising:
the optical transmission/reception device according to claim 10; and
an inspection device for the optical transmission/reception device, wherein the inspection device comprises a first control circuit configured to control the first switch and the second switch such that, at the time of the inspection, the intensity monitor terminal of the driver circuit and the input terminal of the level conversion circuit are connected to each other, and the output terminal of the level conversion circuit and the gain control terminal of the transimpedance amplifier are connected to each other; and
wherein the intensity monitor circuit is configured to determine that the connection between the signal processing LSI and the transmission analog IC and the connection between the reception analog IC and the signal processing LSI are normal in a case where the detected signal intensity has a same frequency component as an intensity change of the inspection signal.

12. The inspection system according to claim 11, wherein:
the inspection device further comprises a second control circuit that, at the time of the inspection, is configured to output to a gain control terminal of the driver circuit a gain control signal whose intensity changes at a frequency different from a frequency of the intensity change of the inspection signal; and
the intensity monitor circuit is configured to determine that the connection between the signal processing LSI and the transmission analog IC and the connection between the reception analog IC and the signal processing LSI are normal and a connection of the gain control terminal of the driver circuit is also normal in a case where the detected signal intensity has the same frequency component as the intensity change of the inspection signal and also has the same frequency component as an intensity change of the gain control signal.

13. An inspection system comprising:
the optical transmission/reception device according to claim 9; and
an inspection device for the optical transmission/reception device, wherein the inspection device comprises:
an inspection signal output circuit that, at a time of an inspection for checking normality of a connection between the signal processing LSI and the transmission analog IC and normality of a connection between the reception analog IC and the signal processing LSI, is configured to output an inspection signal whose signal intensity is periodically changed at a frequency lower than a frequency of the transmission signal to the transmission analog IC;
an intensity monitor circuit configured to detect an intensity of the signal received from the reception analog IC at the time of the inspection; and
a first control circuit configured to control the first switch and the second switch such that, at the time of the inspection, the intensity monitor terminal of the driver circuit and the input terminal of the level conversion circuit are connected to each other, and the output terminal of the level conversion circuit and the gain control terminal of the transimpedance amplifier are connected to each other.

14. The inspection system according to claim 13, wherein the intensity monitor circuit is configured to determine that the connection between the signal processing LSI and the transmission analog IC and the connection between the reception analog IC and the signal processing LSI are normal in a case where the detected signal intensity has a same frequency component as an intensity change of the inspection signal.

15. The inspection system according to claim 14, wherein the inspection device further comprises a second control circuit that, at the time of the inspection, outputs to a gain control terminal of the driver circuit a gain control signal whose intensity changes at a frequency different from a frequency of the intensity change of the inspection signal.

16. The inspection system according to claim 15, wherein the intensity monitor circuit is configured to determine that the connection between the signal processing LSI and the transmission analog IC and the connection between the reception analog IC and the signal processing LSI are normal and a connection of the gain control terminal of the driver circuit is also normal in a case where the detected signal intensity has the same frequency component as the intensity change of the inspection signal and also has a same frequency component as an intensity change of the gain control signal.

17. An inspection system comprising:
an optical transmission/reception device, wherein the optical transmission/reception device comprises:
an optical chip comprising a light transmission device and a light receiving device;
a transmission analog integrated circuit (IC) configured to drive the light transmission device by using a driver circuit in response to a transmission signal;
a reception analog IC configured to amplify a signal output from the light receiving device by using a transimpedance amplifier; and
a signal processing large scale integration (LSI) configured to output the transmission signal to the transmission analog IC and process the signal amplified by the reception analog IC to obtain a reception signal, wherein the signal processing LSI comprises:
an inspection signal output circuit that, at a time of an inspection for checking normality of a connection between the signal processing LSI and the transmission analog IC and normality of a connection between the reception analog IC and the signal processing LSI, is configured to output an inspection signal whose signal intensity is periodically changed at a frequency lower than a frequency of the transmission signal to the transmission analog IC; and
an intensity monitor circuit configured to detect an intensity of the signal received from the reception analog IC at the time of the inspection, wherein the intensity monitor circuit is configured to determine that the connection between the signal processing LSI and the transmission analog IC and the connection between the reception analog IC and the signal processing LSI are normal in a case where the detected signal intensity has a same frequency component as an intensity change of the inspection signal; and
an inspection device for the optical transmission/reception device, wherein the inspection device comprises:
a level conversion circuit configured to convert an intensity monitor signal output from the driver circuit into a level compatible with a gain control signal of the transimpedance amplifier;
a first switch disposed between an intensity monitor terminal of the driver circuit and an input terminal of the level conversion circuit;
a second switch disposed between an output terminal of the level conversion circuit and a gain control terminal of the transimpedance amplifier; and
a first control circuit configured to control the first switch and the second switch such that, at the time of the inspection, the intensity monitor terminal of the driver circuit and the input terminal of the level conversion circuit are connected to each other, and the output terminal of the level conversion circuit and the gain control terminal of the transimpedance amplifier are connected to each other.

18. The inspection system according to claim 17, wherein the inspection device further comprises a second control circuit that, at the time of the inspection, outputs to a gain control terminal of the driver circuit a gain control signal whose intensity changes at a frequency different from a frequency of the intensity change of the inspection signal.

19. The inspection system according to claim 18, wherein the intensity monitor circuit is configured to determine that the connection between the signal processing LSI and the transmission analog IC and the connection between the reception analog IC and the signal processing LSI are normal and a connection of the gain control terminal of the driver circuit is also normal in a case where the detected signal intensity has the same frequency component as the intensity change of the inspection signal and also has the same frequency component as an intensity change of the gain control signal.

20. An inspection system comprising:
an optical transmission/reception device, wherein the optical transmission/reception device comprises:
an optical chip comprising a light transmission device and a light receiving device;
a transmission analog integrated circuit (IC) configured to drive the light transmission device by using a driver circuit in response to a transmission signal;
a reception analog IC configured to amplify a signal output from the light receiving device by using a transimpedance amplifier; and
a signal processing large scale integration (LSI) configured to output the transmission signal to the transmission analog IC and process the signal amplified by the reception analog IC to obtain a reception signal; and
an inspection device for the optical transmission/reception device, wherein the inspection device comprises:
a level conversion circuit configured to convert an intensity monitor signal output from the driver circuit into a level compatible with a gain control signal of the transimpedance amplifier;
a first switch disposed between an intensity monitor terminal of the driver circuit and an input terminal of the level conversion circuit;
a second switch disposed between an output terminal of the level conversion circuit and a gain control terminal of the transimpedance amplifier;
an inspection signal output circuit that, at a time of an inspection for checking normality of a connection between the signal processing LSI and the transmission analog IC and normality of a connection between the reception analog IC and the signal processing LSI, is configured to output an inspection signal whose signal intensity is periodically changed at a frequency lower than a frequency of the transmission signal to the transmission analog IC;
an intensity monitor circuit configured to detect an intensity of the signal received from the reception analog IC at the time of the inspection, wherein the intensity monitor circuit is configured to determine that the connection between the signal processing LSI and the transmission analog IC and the connection between the reception analog IC and the signal processing LSI are normal in a case where the detected signal intensity has a same frequency component as an intensity change of the inspection signal; and
a first control circuit configured to control the first switch and the second switch such that, at the time of the inspection, the intensity monitor terminal of the driver circuit and the input terminal of the level conversion circuit are connected to each other, and the output terminal of the level conversion circuit and the gain control terminal of the transimpedance amplifier are connected to each other.

21. The inspection system according to claim 20, wherein the inspection device further comprises a second control circuit that, at the time of the inspection, is configured to output to a gain control terminal of the driver circuit a gain control signal whose intensity changes at a frequency different from a frequency of the intensity change of the inspection signal.

22. The inspection system according to claim 21, wherein the intensity monitor circuit is configured to determine that the connection between the signal processing LSI and the transmission analog IC and the connection between the reception analog IC and the signal processing LSI are normal and a connection of the gain control terminal of the driver circuit is also normal in a case where the detected signal intensity has the same frequency component as the intensity change of the inspection signal and also has a same frequency component as an intensity change of the gain control signal.
